(19) United States
(12) Patent Application Publication
(10) Pub. No.: US 2005/0160185 A1
(43) Pub. Date: Jul. 21, 2005

(54) Electrical home appliance having access control means

(76) Inventors: Satoshi Matsuura, Kyoto (JP); Atsushi Nakamura, Kanagawa (JP); Atsushi Hattori, Tokyo (JP); Tomohiro Inagawa, Kanagawa (JP); Takashi Kashimoto, Nara (JP); Keiji Ogawa, Nara (JP)

Correspondence Address: HARNESS, DICKEY & PIERCE, P.L.C., P.O. BOX 828, BLOOMFIELD HILLS, MI, 48303, US

(21) Appl. No.: 10/498,696

(22) PCT Filed: Dec. 16, 2002
(86) PCT No.: PCT/JP02/13117

(30) Foreign Application Priority Data
Dec. 14, 2001 (JP) 2001-382222

(51) Int. Cl. G06F 3/00

(52) U.S. Cl. 710/1

(57) ABSTRACT

In order to ensure the security by access control, or the like, using a limited input/output interface of a household electric appliance without complicated setting manipulations, a refrigerator includes a filter section which permits only establishing a communication with a relay server having a specific IP address. The relay server includes a relay control section for relaying a communication between the refrigerator and a cellular mobile phone or a personal computer, a connectable device database in which a partner device whose communication is permitted by the relay control section to be relayed is registered in conjunction with the refrigerator, and a data conversion section for performing data conversion at the time of the relay according to a difference in the input/output interface between the refrigerator and the personal computer, or the like. The refrigerator and the personal computer, or the like, can establish a communication through the relay server.

### TECHNICAL FIELD

The present invention falls within a technical field relating to a household electric appliance capable of connecting with a network, a server for relaying data between such a household electric appliance and other devices, and a method for communicating with the household electric appliance.

### BACKGROUND ART

As the dispersion of networks, such as the Internet, and the like, a broader variety of household electric appliances have been connected to the networks. These household electric appliances are identified by addresses in communication.

Meanwhile, in recent years, the service of readily confirming whether or not accident happened to an aged person who lives alone, or the like, by monitoring the use status of a household electric appliance which is used in ordinary life, a so-called safety monitoring service, has been started.

In the case where such monitoring of the use status of a household electric appliances is performed using a household electric appliance which is connected to a network all the time, stringent access control needs to be exerted for privacy protection.

Although there are various known techniques for ensuring the security in networks, such as access control, and the like, stringent access control and communication flexibility (usability) are generally in a tradeoff relationship, and it is not necessarily easy to achieve both of them. Especially when an input/output interface with limited manipulability, such as an interface provided to a household electric appliance, is used and a primary user of the household electric appliance is an aged person, it is difficult to enforce complicated settings for access control.

Devices designed for the purpose of controlling permission for communication are disclosed in, for example, Japanese Unexamined Patent Publication No. 2001-36636 and Japanese Patent Publication No. 2,634,933. These devices impose restrictions on signaling in a line connection through a public line, or the like, or control the connection of lines by ID number verification at the time of an incoming call, and are therefore inapplicable to improvement of the security in a network which provides a connection all the time. The settings for line control are determined through a keyboard (operation panel) of a personal computer or a decoding terminal device. It is difficult to achieve both security and manipulability with a limited user interface of a household electric appliance.

### DISCLOSURE OF INVENTION

In view of the above problems, an objective of the present invention is to readily ensure the security by access control, or the like, using a limited input/output interface of a household electric appliance without complicated setting manipulations.

In order to achieve the above objective, the first household electric appliance of the present invention is a household electric appliance capable of connecting with a network, comprising: a network interface which is connected to the network; and access control means for receiving only an access from one device having a predetermined address through the network interface to give the device a permission for communication.

With the above structure, only one device having a predetermined address can access the household electric appliance. Therefore, the security is readily ensured without complicated setting manipulations for authentication information, or the like, even when the household electric appliance is connected to the network all the time.

The second household electric appliance of the present invention is based on the first household electric appliance, wherein the device permitted for communication is a device to which a provider of the household electric appliance provides a service related to the household electric appliance.

The third household electric appliance of the present invention is based on the second household electric appliance, wherein the device permitted for communication has in advance information for specifying the household electric appliance to which the service is to be provided; and the household electric appliance further includes address transmission means for transmitting an address of the household electric appliance over the network, together with the information for specifying the household electric appliance, to the device permitted for communication.

The fourth household electric appliance of the present invention is based on the second household electric appliance, wherein the service related to the household electric appliance includes at least one of the service of controlling the household electric appliance, monitoring the status of the household electric appliance, or providing maintenance of the household electric appliance, the service of providing information related to the household electric appliance, and the service of relaying a communication between the household electric appliance and another communication device.

The fifth household electric appliance of the present invention is based on the fourth household electric appliance, wherein the household electric appliance is a refrigerator.

With the above structures, a user can receive various services related to the household electric appliance while the security is ensured as described above.

The sixth household electric appliance of the present invention is based on the fourth household electric appliance, wherein the device permitted for communication stores in advance information for specifying the household electric appliance and information for specifying a communication device whose communication is to be relayed; the device permitted for communication receives an address of the household electric appliance over the network together with the information for specifying the household electric appliance; the device permitted for communication stores registration information including the address of the household electric appliance and the information for specifying the communication device in conjunction with each other based on the information for specifying the household electric appliance, the information for specifying a communication device whose communication is to be relayed, and the address of the household electric appliance; the device permitted for communication provides the service of relaying a communication between the household electric appliance and the communication device according to the registration information; and the household electric appliance further includes address transmission means for transmitting the address of the household electric appliance, together with the information for specifying the household electric appliance, to the device permitted for communication.

The seventh household electric appliance of the present invention is based on the fourth household electric appliance, wherein: the device permitted for communication stores in advance information for specifying the household electric appliance and information for specifying a user of the household electric appliance; the device permitted for communication receives an address of the household electric appliance over the network together with the information for specifying the household electric appliance; the device permitted for communication stores registration information including the address of the household electric appliance and authentication information in conjunction with each other based on the information for specifying the household electric appliance, the information for specifying a user of the household electric appliance, and the address of the household electric appliance, the authentication information including the information for specifying the user of the household electric appliance and a password; the device permitted for communication provides the service of relaying a communication between the household electric appliance and the communication device according to the registration information; and the household electric appliance further includes address transmission means for transmitting the address of the household electric appliance, together with the information for specifying the household electric appliance, to the device permitted for communication.

The eighth household electric appliance of the present invention is based on the fourth household electric appliance, wherein: the device permitted for communication stores registration information including the address of the household electric appliance and authentication information in conjunction with each other, the authentication information including the information for specifying a user of the household electric appliance and a password; the device permitted for communication provides the service of relaying a communication between the household electric appliance and the communication device according to the registration information; and the household electric appliance further includes information acquisition means for acquiring information specifying the user which is stored by the device permitted for communication in memory means from which the household electric appliance can acquire information, and address transmission means for transmitting the address of the household electric appliance, together with the information for specifying the user, to the device permitted for communication.

With the above structures, an address of the household electric appliance, or the like, is securely stored in a device which is permitted to communicate with the household electric appliance, such as a relay server, or the like, and such device readily relays a communication between the household electric appliance and the communication device. Thus, even if a device which is directly permitted to establish a communication with the household electric appliance is one relay server, or the like, restrictions on a communication partner are relaxed without impairing the security.

The ninth household electric appliance of the present invention is based on the eighth household electric appliance, which further comprises: user specifying information storage means for storing the information that specifies the user, the information being obtained from the information acquisition means; and communication interruption means for interrupting a communication with the device permitted for communication if the information for specifying the user which is stored in the user specifying information storage means is different from the information for specifying the user which is newly obtained from the information acquisition means.

In the above structure, a communication with the server, or the like, is interrupted when the information that specifies the user is changed. For example, when the user is replaced with another by the transfer of the household electric appliance, or the like, the new user is prevented from using a service which is to be charged on the former user, and the former user is prevented from accessing the household electric appliance from a communication device whose communication is relayed by the server.

The tenth household electric appliance of the present invention is based on the fourth household electric appliance, wherein the another communication device whose communication with the household electric appliance is permitted to be relayed is modified only based on an instruction from the device having the predetermined address or an instruction from a device which is permitted for communication by the device having the predetermined address.

The eleventh household electric appliance of the present invention is based on the tenth household electric appliance, which further comprises: a display section for displaying information indicative of one or more devices whose communication can be permitted to be relayed due to the modification; and a manipulation section for receiving a selection manipulation among the devices displayed on the display section, wherein the modification/addition means modifies or adds the device whose communication is permitted to be relayed, according to the selection manipulation.

The twelfth household electric appliance of the present invention is based on the first household electric appliance, wherein the network interface is connected to the network via wireless communication.

The thirteenth household electric appliance of the present invention is based on the first household electric appliance, wherein: the access control means receives, at least in its default state, only an access from one device having the predetermined address to give the device a permission for communication; and the household electric appliance further includes modification/addition means for modifying or adding the device permitted for communication only based on an instruction from the device having the predetermined address or an instruction from a device which is permitted for communication by the device having the predetermined address.

The fourteenth household electric appliance of the present invention is based on the twelfth household electric appliance, wherein: a display section for displaying information indicative of one or more devices which can be permitted for communication; and a manipulation section for receiving a selection manipulation among the devices displayed on the display section, wherein the modification/addition means modifies or adds the device permitted for communication according to the selection manipulation.

The fifteenth household electric appliance of the present invention is based on the fourteenth household electric appliance, wherein the household electric appliance is a refrigerator.

With the above structures, a device permitted for communication can be modified or added, and a communication is permitted within a limited extent. Therefore, communication flexibility is improved without deteriorating the security. Especially, even when a network interface which accepts a wireless signal is used so that access control with a router, or the like, is difficult, the security is readily ensured.

The sixteenth server of the present invention is a server capable of communicating with a household electric appliance which receives only an access from one device having a predetermined address through a network interface to give the device a permission for communication, the server comprising: a relay permission database in which information for specifying a communication device whose data communication with the household electric appliance is permitted to be relayed is registered in conjunction with the household electric appliance; and relay means for relaying data between the household electric appliance and the communication device according to the information registered in the relay permission database.

With the above structure, even when the household electric appliance is accessed by limited devices which have a permission to access, a device, such as a personal computer, or the like, whose communication is permitted to be relayed by the server, can communicate with the household electric appliance by relaying of the relay means. Specifically, complicated settings, such as settings for communication permission in the household electric appliance, settings for relay permission in the server, or the like, may be determined using a personal computer which has a variety of user interfaces, or the like. Therefore, it is only required that simple display and manipulations are provided in the household electric appliance. Thus, convenience for a user of the household electric appliance is improved, while the high security is achieved as described above.

The seventeenth server of the present invention is based on the sixteenth server, which further comprises conversion means for converting data transmitted between the household electric appliance and the communication device to a format which complies with input/output interfaces of the household electric appliance and the communication device.

With the above structure, in each of the household electric appliance and other devices, display and manipulations are performed in accordance with the display characteristics and manipulation properties. Therefore, it may only be required that simple display and manipulations are provided in the household electric appliance. Thus, convenience is readily improved in both the household electric appliance and the other devices.

The eighteenth server of the present invention is based on the sixteenth server, which further comprises: permission device information storage means for storing information that specifies the household electric appliance and information that specifies the communication device; and registration means for registering the address of the household electric appliance and the information that specifies the communication device in conjunction with each other in the relay permission database when the address of the household electric appliance over the network is received from the household electric appliance together with the information that specifies the household electric appliance, based on the received information and the information stored in the permission device information storage means.

The nineteenth server of the present invention is a server capable of communicating with a household electric appliance which receives only an access from one device having a predetermined address through a network interface to give the device a permission for communication, the server comprising: a relay permission database in which authentication information is registered in conjunction with the household electric appliance, the authentication information being used for determining whether or not to permit relaying of data between the household electric appliance and another communication device; and relay means for relaying data between the household electric appliance and the communication device according to the information registered in the relay permission database.

Also with the above structures, convenience for a user of the household electric appliance is improved as described above, while high security is ensured.

The twentieth server of the present invention is based on the nineteenth server, which further comprises conversion means for converting data transmitted between the household electric appliance and the communication device to a format which complies with input/output interfaces of the household electric appliance and the communication device.

With the above structure, in each of the household electric appliance and other devices, display and manipulations are performed in accordance with the display characteristics and manipulation properties. Therefore, it may only be required that simple display and manipulations are provided in the household electric appliance. Thus, convenience is readily improved in both the household electric appliance and the other devices.

The twenty-first server of the present invention is based on the nineteenth server, wherein: the authentication information registered in the relay permission database includes information that specifies a user of the household electric appliance and a password; and the server further includes household electric appliance specifying information storage means for storing the information that specifies the household electric appliance, which is received together with the authentication information, in conjunction with the information that specifies the user, and registration means for registering the address of the household electric appliance and the authentication information in conjunction with each other in the relay permission database when the address of the household electric appliance over the network is received from the household electric appliance together with the information that specifies the household electric appliance, based on the received information and the information stored in the household electric appliance specifying information storage means.

The twenty-second server of the present invention is based on the nineteenth server, wherein: the authentication information stored in the relay permission database includes information that specifies a user of the household electric appliance and a password; and the server further includes user information output means for allowing memory means which is capable of exchanging information with the household electric appliance to store the information that specifies the user, and registration means for registering an address of the household electric appliance over the network, which is received from the household electric appliance based on the information stored in the memory means, and the authentication information in conjunction with each other in the relay permission database based on the address of the household electric appliance and the information that specifies the user.

The twenty-third server of the present invention is based on the twenty-second server, wherein: the memory means is a communication device capable of communicating with each of the household electric appliance and the server; and the user information output means transmits the information that specifies the user to the communication means.

The twenty-fourth server of the present invention is based on the twenty-second server, wherein: the memory means is a recording medium insertable to the household electric appliance or a device connected to the household electric appliance; and the user information output means records the information that specifies the user in the recording medium.

Also with the above structures, convenience for a user of the household electric appliance is improved as described above, while high security is ensured as described above.

The twenty-fifth communication method is a method for communicating with a household electric appliance, comprising the steps of: referring to a relay permission database in which a household electric appliance and a communication device are registered in conjunction with each other, the household electric appliance receiving only an access from one device which has a predetermined address through a network interface to give the device a permission for communication, the communication device whose data communication with the household electric appliance being permitted to be relayed; and relaying data between the household electric appliance and the communication device according to the information registered in the relay permission database.

The twenty-sixth communication method is a method for communicating with a household electric appliance, comprising the steps of: referring to a relay permission database in which a household electric appliance and authentication information are registered in conjunction with each other, the household electric appliance receiving only an access from one device which has a predetermined address through a network interface to give the device a permission for communication, the authentication information being used for determining whether or not to permit relaying data to/from the household electric appliance; and relaying data between the household electric appliance and the communication device according to the information registered in the relay permission database.

With the above structures, even when the household electric appliance is accessed by limited devices which have a permission to access, a device, such as a personal computer, or the like, whose communication is permitted to be relayed, can communicate with the household electric appliance by relaying at the step of relaying data. Complicated settings, such as settings for communication permission in the household electric appliance, settings for relay permission in the server, or the like, may be performed using a personal computer which has a variety of user interfaces, or the like. Therefore, it may only be required that simple display and manipulations are achieved in the household electric appliance. Thus, convenience for a user of the household electric appliance is improved, while the high security is ensured as described above.

### BRIEF DESCRIPTION OF DRAWINGS

FIG. 1 shows a network system including a refrigerator 101 and a relay server 103 according to embodiment 1 of the present invention.

FIG. 2 is a block diagram showing a structure of principle part of the refrigerator 101 and the relay server 103 of embodiment 1.

FIG. 3 illustrates an example of communication control between the refrigerator 101 and an access terminal by schematically showing a device arrangement according to embodiment 1.

FIG. 4 illustrates an example of communication control between the refrigerator 101 and an access terminal along with the time flow according to embodiment 1.

FIG. 5 is a front view of a display example of a personal computer 106 according to embodiment 1.

FIG. 6 is a front view of a display example of the refrigerator 101 according to embodiment 1.

FIG. 7 shows a structure of a network system of embodiment 1 wherein an ASP server 141 is used in addition to the relay server 103.

FIG. 8 illustrates an example of registration manipulation in the ASP server 141 according to embodiment 1.

FIG. 9 shows the structure of a network system of embodiment 1 wherein a portal server 142 is used.

FIG. 10 is a block diagram showing a structure of principle part of a refrigerator 101 and a relay server 103 of embodiment 2.

FIG. 11 illustrates an example of communication control between the refrigerator 101 and an access terminal by schematically showing a device arrangement according to embodiment 2.

FIG. 12 illustrates an example of communication control between the refrigerator 101 and an access terminal along with the time flow according to embodiment 2.

FIG. 13 is a block diagram showing a structure of principle part of a refrigerator 101 and a relay server 103 of embodiment 3.

FIG. 14 illustrates an example of communication control between the refrigerator 101 and an access terminal by schematically showing a device arrangement according to embodiment 3.

FIG. 15 illustrates an example of communication control between the refrigerator 101 and an access terminal along with the time flow according to embodiment 3.

FIG. 16 illustrates an example of communication control between the refrigerator 101 and an access terminal by schematically showing a device arrangement according to embodiment 4.

FIG. 17 illustrates an example of communication control between the refrigerator 101 and an access terminal along with the time flow according to embodiment 4.

### BEST MODE FOR CARRYING OUT THE INVENTION

Hereinafter, embodiments of the present invention are described with reference to the drawings.

(Embodiment 1)

Hereinafter, embodiment 1 of the present invention is described with reference to the drawings.

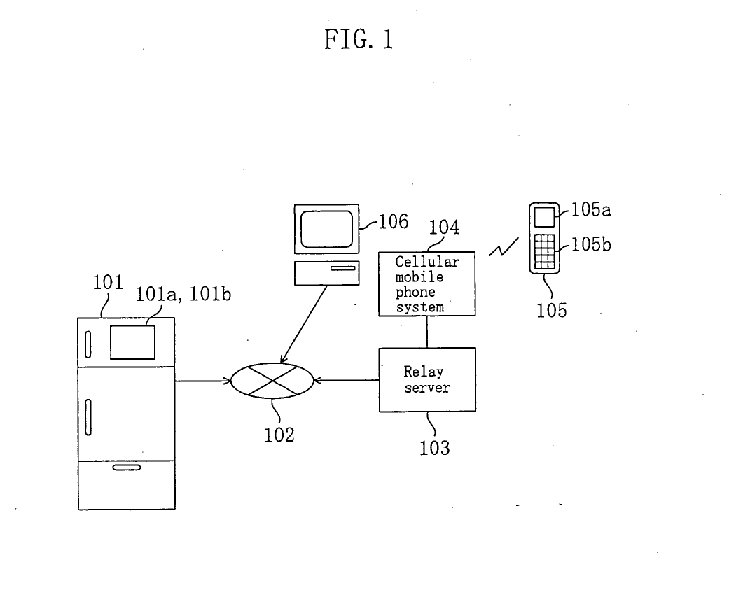

FIG. 1 shows a structure of a network system including a refrigerator 101 and a relay server 103 according to embodiment 1 of the present invention. The refrigerator 101 includes a display panel 101a and a touch panel 101b and is capable of communicating with the relay server 103 through the network 102 (e.g., the Internet). The relay server 103 is capable of communicating with a cellular mobile phone 105, which has a display section 105a and a manipulation section 105b, and a personal computer 106 through a cellular mobile phone system 104 or the network 102. The relay server 103 relays data between the cellular mobile phone 105 and personal computer 106 and the refrigerator 101. The relay server 103 may provide a service other than relaying of data, such as provision of various information, or the like.

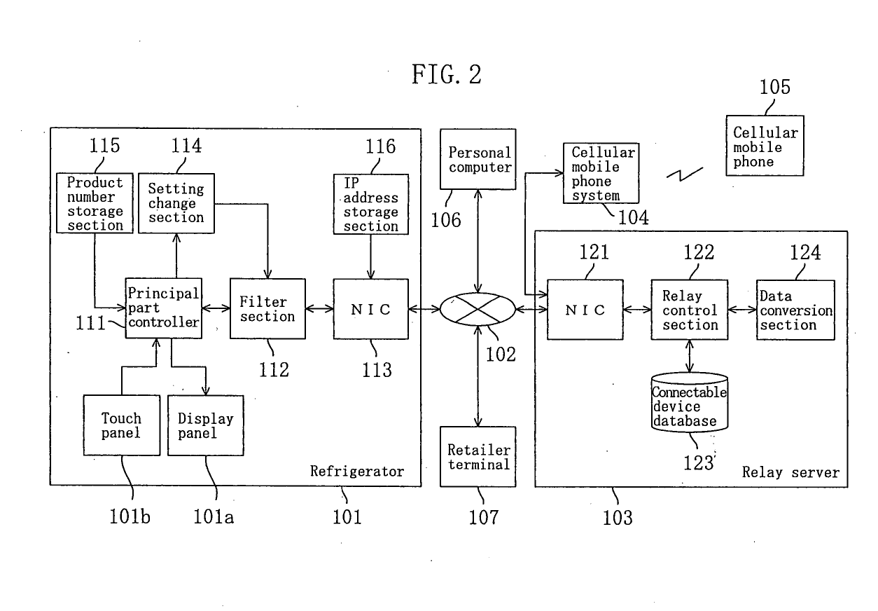

The refrigerator 101 and the relay server 103 have structures as shown in FIG. 2. In FIG. 2, a principal part controller 111 of the refrigerator 101 performs control operations for principal part of the refrigerator 101, such as cooling, or the like, and controls provision of various services by the communication with the relay server 103.

A filter section 112 permits only a communication with a partner device having a specific IP (Internet Protocol) address. When the refrigerator 101 is in a default state, only a communication with the relay server 103 is permitted. It is preferable that various authentication protocols, IPsec protocol (Security Architecture for the Internet Protocol) of IPv6 (Internet Protocol version 6), or the like, are used for the purpose of improving the security of a communication between the refrigerator 101 and the relay server 103, or the like.

An network interface card (NIC) 113 performs a process of a communication protocol with the network 102.

A setting change section 114 changes the settings of a communication partner device which is permitted by the filter section 112 to communicate with the refrigerator 101.

A product number storage section 115 stores a product number allocated to the refrigerator 101.

An IP address storage section 116 stores an IP address which is uniquely allocated to the refrigerator 101 over the network 102.

An NIC 121 of the relay server 103 performs a process of a communication protocol with the network 102 as does the NIC 113.

A relay control section 122 relays a communication between the refrigerator 101 and the cellular mobile phone 105 or the personal computer 106. That is, even if the refrigerator 101 is capable of communicating only with the relay server 103 as described above, the relay function of the relay control section 122 allows the refrigerator 101 to communicate with the personal computer 106, or the like. Furthermore, the relay control section 122 ensures the communication security and provides communication flexibility without performing complicated setting manipulations in the refrigerator 101.

In a connectable device database 123, a partner device, data transmitted to/from which is relayed by the relay control section 122, is registered in conjunction with the refrigerator 101.

When data is relayed, a data conversion section 124 performs data conversion according to the differences in the input/output interface between the refrigerator 101 and the personal computer 106, or the like, whereby display and manipulations at the refrigerator 101 are simplified so as to be readily operated, while various display forms and manipulations can be performed at the personal computer 106, or the like.

An operation of the network system having the above structure is described.

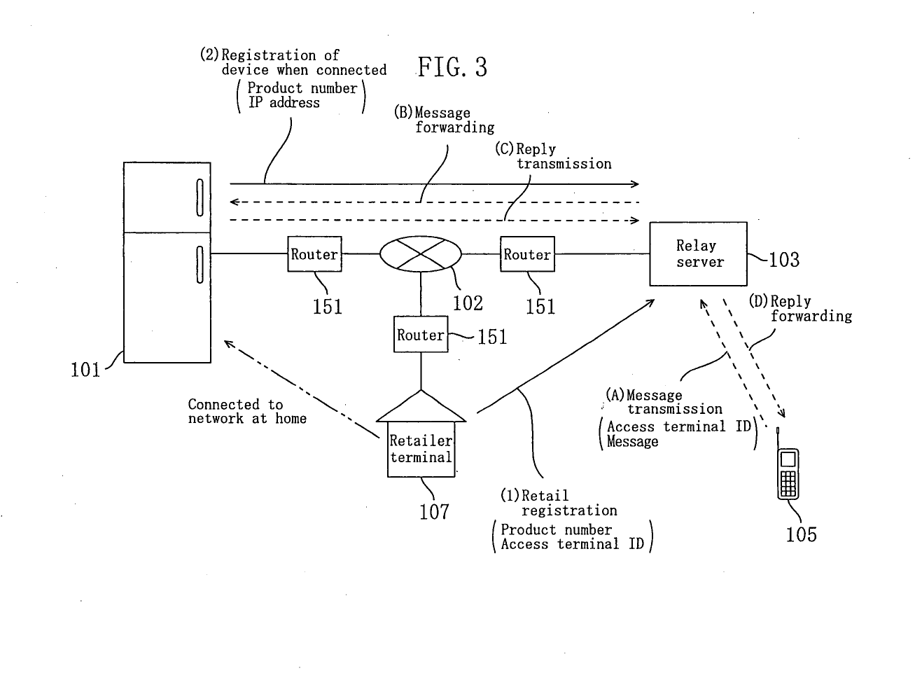

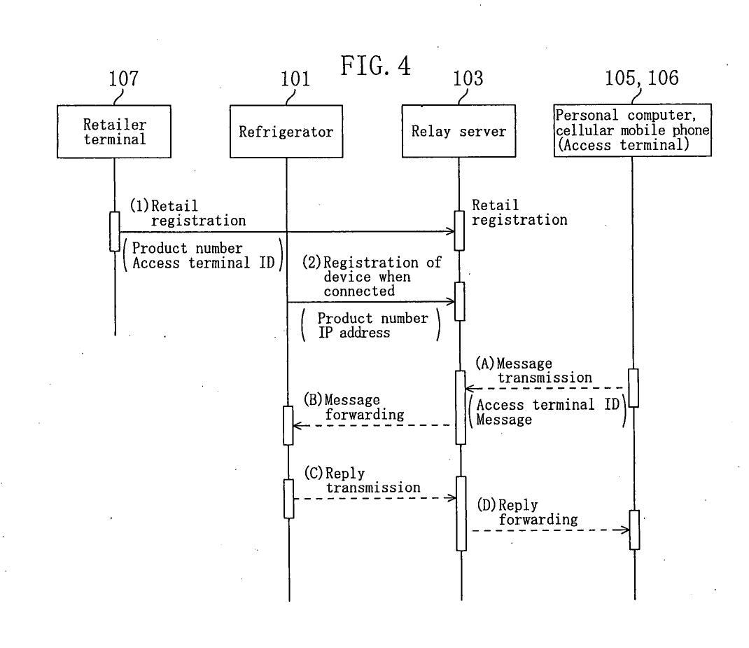

At the default state as of sold, the refrigerator 101 is capable of communicating with the relay server 103 due to the communication control by the filter section 112. For example, by registering access terminals, data transmitted to/from which is relayed by the relay server 103, such as the cellular mobile phone 105, the personal computer 106, or the like, in the relay server 103 when the refrigerator 101 is sold, communications between the refrigerator 101 and the access terminals are enabled under relay control by the relay control section 122. More specifically, relay of data is performed by the registration process and communication process which are shown in FIGS. 3 and 4 and which will be described in the following sections. Herein, although FIGS. 3 and 4 illustrate the same operation, FIG. 3 schematically shows an arrangement of devices, and FIG. 4 shows the procedure of communications along with the time flow.
(1) In the first place, the relay server 103 is accessed from a retailer terminal 107 in order to perform a retail registration operation wherein a product number of the refrigerator 101, an access terminal ID, and the like, are registered.
(2) When the refrigerator 101 is connected to the network 102, a connection registration process is performed wherein the relay server 103 is notified by the refrigerator 101 of the product number and IP address of the refrigerator 101. By this operation, the access terminal ID and the IP address, which are associated with each other by collation of the product number, are registered in the connectable device database 123 of the relay server 103. The access terminal ID may be, for example, the IP address of the personal computer 106, the phone number of the cellular mobile phone 105, or the like. Alternatively, the access terminal ID may be authentication information which is input when the relay server 103 is accessed, such as an ID number, a password, and the like.

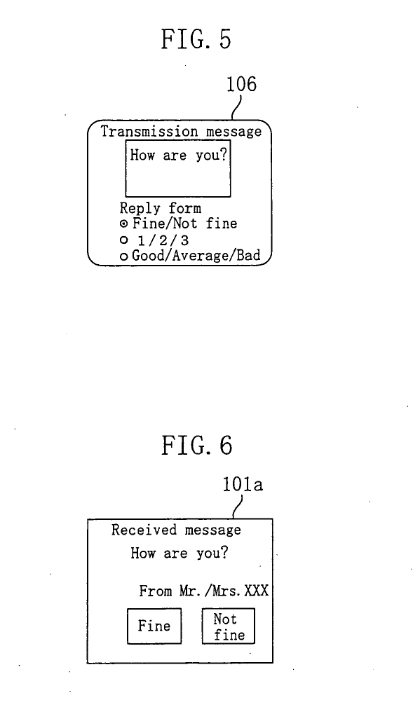

The relay control is performed in the relay control section 122 based on the above registration, whereby a communication is established between the refrigerator 101 and the cellular mobile phone 105.
(A) For example, a message is transmitted from an access terminal to the relay server 103.
(B) The message is forwarded by the relay server 103 to the refrigerator 101 (forwarding of the message from the relay server 103 to the refrigerator 101 may be performed according to an access which is made by the refrigerator 101 at a predetermined timing or may be performed by a push from the relay server 103).
(C) & (D) When the refrigerator 101 replies, the reply is also transmitted to the access terminal. During transmission of the reply, data conversion is performed by the data conversion section 124 as necessary. Specifically, the message to be transmitted and the designated format of a reply to the message are transmitted to the relay server 103 by the personal computer 106 as shown in FIG. 5, and the data conversion section 124 performs a predetermined conversion on the transmitted message data to forward it to the refrigerator 101, so that the display of FIG. 6, for example, is presented on the display panel 101a of the refrigerator 101.

The personal computer 106 generally has a relatively large screen and an input device, such as a keyboard, a mouse, and the like, and therefore can readily offers various input and representation methods which use a Web browser, for example. Even if the refrigerator 101 has a relatively small screen or can make a selection from only two or three choices with a touch panel or several buttons, message conversion by the data conversion section 124 helps to offer display that is readily observed and an operation method that enables easy operations. In such a conversion, the name of a sender, e.g., “from Mr./Ms. xxx” as shown in FIG. 6, may be automatically added to the message. Also when the cellular mobile phone 105 is used to transmit a message and receive a reply to the message, transmission of any message to and reception of the reply from the refrigerator 101 are readily performed with operation/display methods appropriate to the screen size, the number of keys, and the like. When a mail including a predetermined keyword and a message, e.g., “transmission message: How are you?/reply: Fine-Not fine”, in the text of the mail is transmitted, the content of the message and protocol are converted to readily offer the display of FIG. 6 or forward the reply to the personal computer 106 in the form of a mail.

As described above, the relay function of the relay control section 122 of the relay server 103 is utilized for data transmission/reception, whereby flexible communications are achieved without decreasing the security or making complicated setting manipulations at the refrigerator 101.

As described above, due to the relay function of the relay server 103, modifications to and addition of access terminals which can communicate with the refrigerator 101 can be realized by changing the registered information in the connectable device database 123 of the relay server 103. These modifications can readily achieved using, for example, the personal computer 106, or the like, with a user interface having high manipulability, without requiring any manipulation at the refrigerator 101.

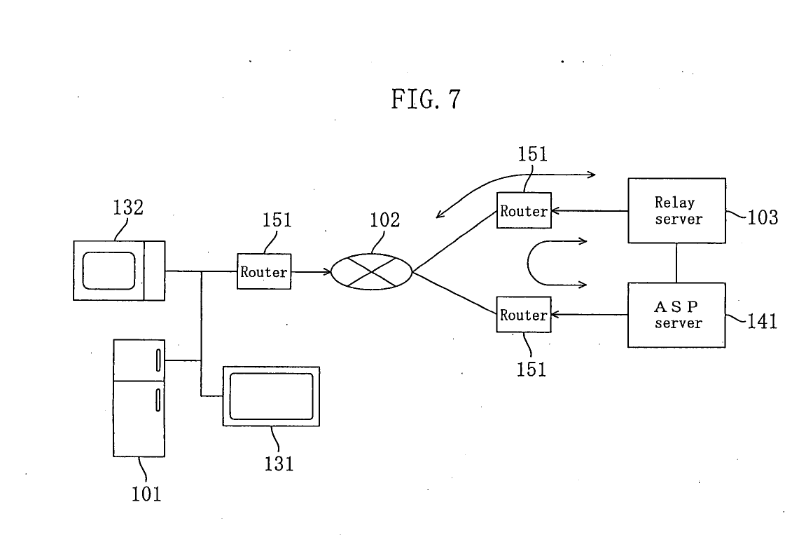

Alternatively, in the same manner, a communication with a server other than an access terminal may be relayed by the relay server 103. For example, it is considered to be realistic in view of user support and maintenance that the relay server 103 which is connected at the time of sales of the refrigerator 101 is provided by a party which is related to the distribution of the relay server 103, such as the manufacturer, retailer, post-sale support company of the refrigerator 101, or the like. On the other hand, however, the variety of services is increased by making one or more of various services, such as provision of information, or the like, selectable according to the preference of a user, the cost, or the like. Alternatively, various services may be collectively offered to user's products of different manufacturers. Specifically, the information registered in the connectable device database 123 is changed such that a communication between the refrigerator 101 and an ASP server 141, which is a server of a application service provider, such as a provider of an information providing service, is relayed by the relay server 103, for example, as shown in FIG. 7.

Specific examples of the above services include recipe information provided to cooking devices, descriptions provided to washing machines about the materials of cloths and how to wash them, maintenance information provided to air conditioners, such as a notice of filter exchange, and the like, provision of information (contents), such as product information (information about new products and replacement purchases), and the like, mechanical breakdown diagnosis and malfunction detection notice, unattended (programmed) recording in recording devices, information about device control, such as power control for energy saving, etc. Further, the service of confirming the safety of a user by checking the opening/closing of the door of the refrigerator 101 from the personal computer 106, or the like, or by receiving a mail which includes such information, and the service of confirming the temperature of a warehouse or food stocks in the warehouse from the cellular mobile phone 105, or the like, are also possible.

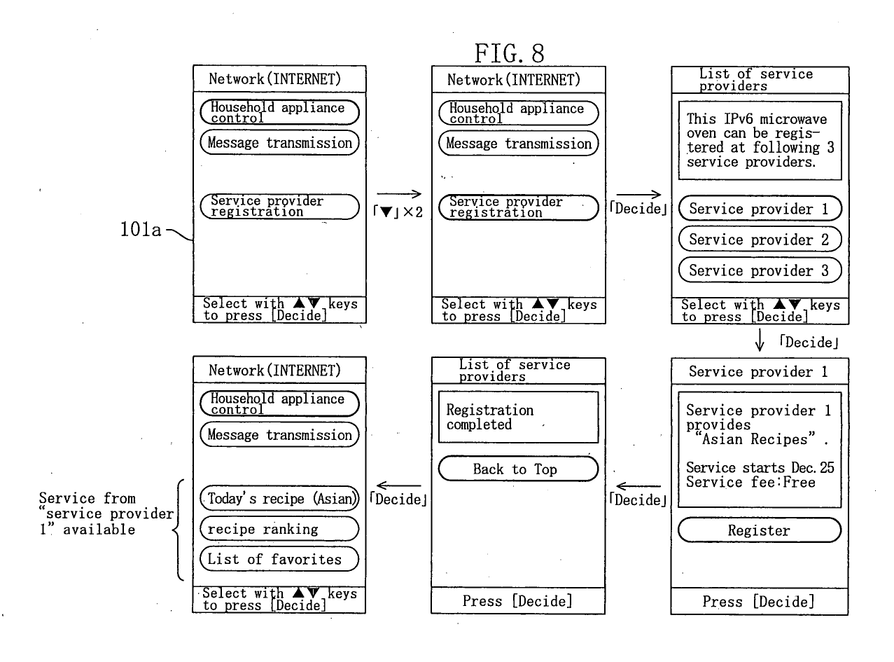

The settings for receiving other services from the other servers as shown above may be determined by the personal computer 106, or the like. Alternatively, for example, the settings can be readily determined by displaying candidate service provider companies (servers) such that they are selectable by the operation of a key or touch panel as shown in FIG. 8, even if a display console section of the refrigerator 101, or the like, is simple. In the case where services appropriate to a household electric appliance are available from other servers, the servers may be notified of the product number stored in the relay server 103, or the like. Furthermore, the setting of a communication partner device with which a communication is permitted by the filter section 112 of the refrigerator 101 may be altered by the above display and manipulations.

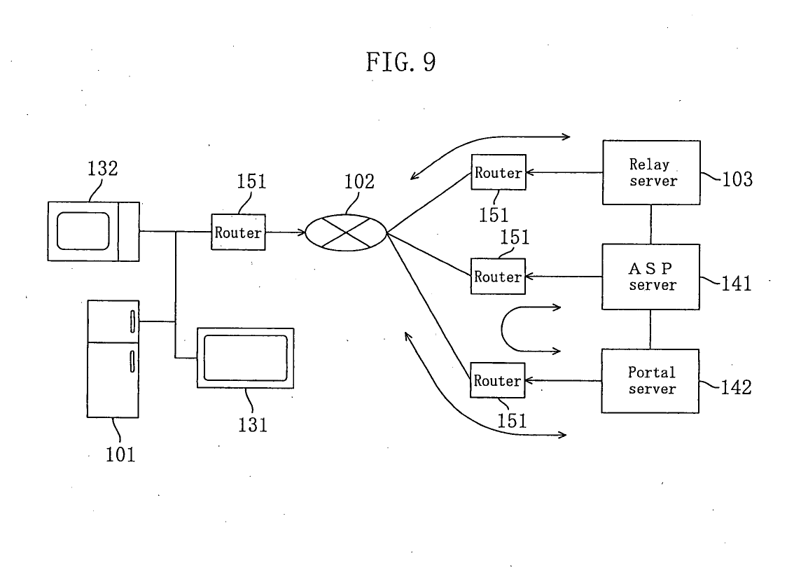

Further, as shown in FIG. 9, a communication with a portal server 142 which has the same relay function as that of the relay server 103 may be enabled such that communications with the ASP server 141, and the like, through the portal server 142 can be established. By using such a portal server, the load of relay which is imposed on the relay server 103 is reduced. Furthermore, in the case of using the above portal server 142, an instruction to change the settings of the filter section 112 is sent to the setting change section 114 of the refrigerator 101 (FIG. 2) from the personal computer 106, the cellular mobile phone 105 or the relay server 103 (or the refrigerator 101 itself). According to the instruction, a device which can establish a direct communication with the refrigerator 101 is switched to the portal server 142, or the portal server 142 is added in addition to the relay server 103.

In FIGS. 7 and 9, in addition to the refrigerator 101, a digital television set 131 and a microwave oven 132 are connected to each other, and these appliances are connected to the network 102 through a router (home router) 151. As shown, a plurality of devices may be connected in a local area network. In this case, communications other than the communications established through the network 102 are readily established among the devices using local addresses without affecting the security. Furthermore, the digital television set 131 and the microwave oven 132 may be structured to be capable of communicating only with specific partner devices, such as the relay server 103, the servers of other product manufacturers, or the like, as is the refrigerator 101.

The display and manipulations at the refrigerator 101 are not limited to those achieved with the display panel 101a and the touch panel 101b, but various devices may be employed. Since complicated setting manipulations can be performed by the personal computer 106, a simplified image display which enables a user to make a selection among several choices while observing a simple screen is offered, instead of improving the multi-functionality, whereby the manipulability is improved for a user who is not accustomed to manipulating devices. The display panel 101a, or the like, is not necessarily fixed to the refrigerator 101, but may be a detachable slave device which can establish a communication with the main part of the refrigerator 101 by wireless, or the like. In this case, exchange of massages can be performed at a place outside the kitchen, and thus, the convenience is further improved. Such slave device, or the like, produces only a low output, and therefore, the power consumption thereof is readily reduced. Further, it is not necessary to subscribe to a public line service, and communications are established only between the slave device and the main part of the refrigerator 101. Thus, the security level may be relatively low.

(Embodiment 2)

Hereinafter, a network system is described wherein determination whether or not to permit use of services, such as relaying of communications, at the cellular mobile phone 105, or the like, is made not with an access terminal ID as described above, but with a user ID. It should be noted that, in the following embodiments, components having the same functions as those of the components of embodiment 1 are denoted by the same reference numerals, and descriptions thereof are omitted.

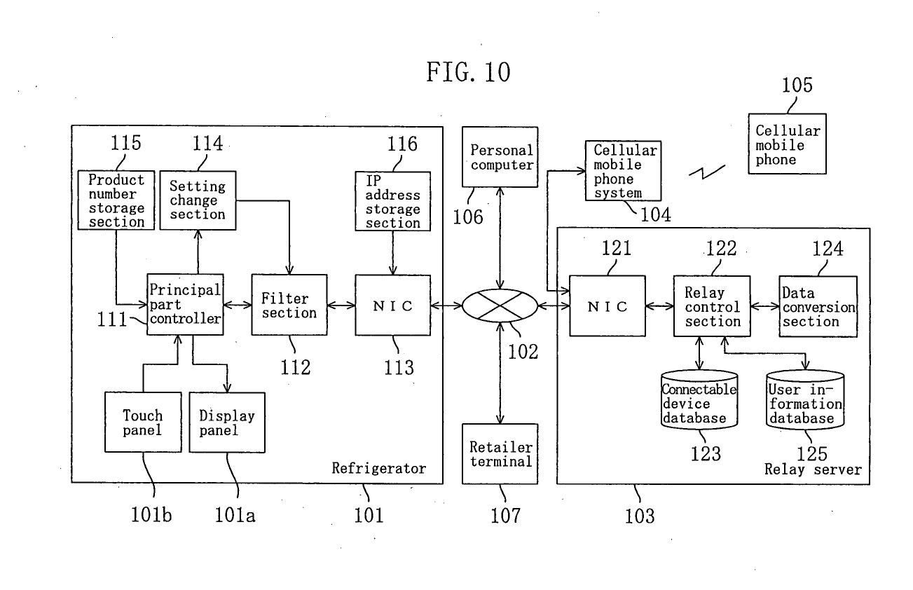

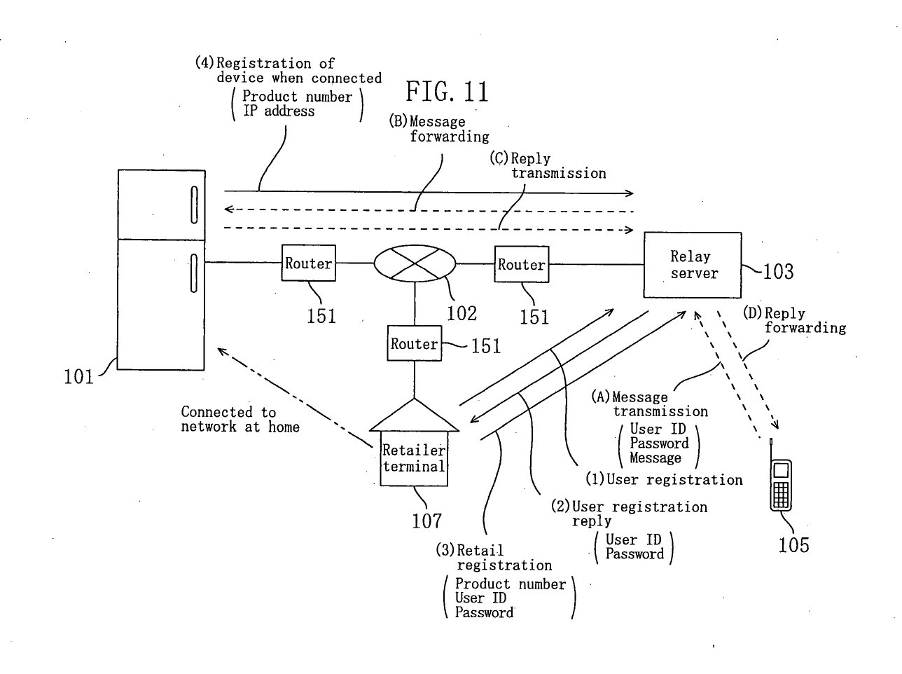

Although the refrigerator 101 of embodiment 2 is the same as that of embodiment 1 as shown in FIG. 10, the relay server 103 of embodiment 2 is different from that of embodiment 1 in that the relay server 103 of embodiment 2 includes a user information database 125 in addition to the components of the relay server of embodiment 1. The user information database 125 stores user IDs and passwords for respective users. Receiving a relay request to the refrigerator 101 from the cellular mobile phone 105 or the personal computer 106, the user information database 125 collates user IDs and passwords to determine whether or not to permit relaying to the refrigerator 101 registered in the connectable device database 123, or the like.

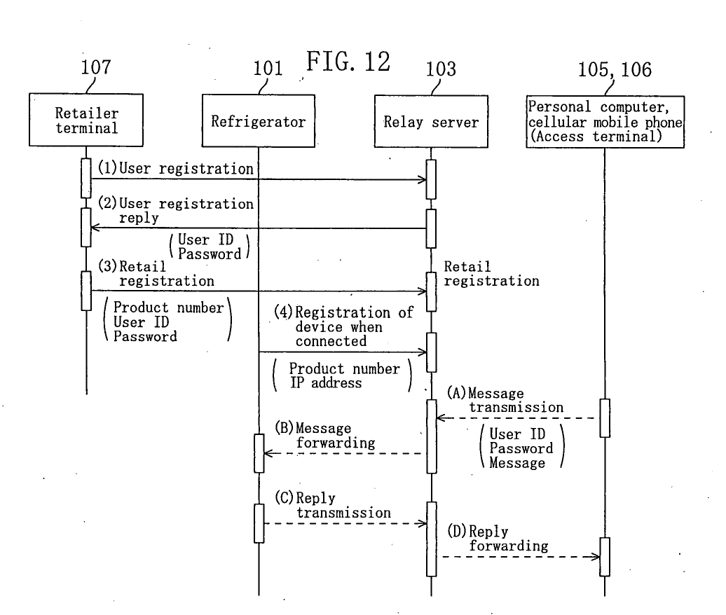

In this network system, registration of a user and establishment of a communication are performed as described below and as shown in FIGS. 11 and 12:
(1) The relay server 103 is accessed from a retailer terminal 107 to request user registration. This user registration is performed only one time at the first purchase of a product of a manufacturer.
(2) At the relay server 103, the user information is registered in the user information database 125 according to the above request. Meanwhile, a user ID and a password are issued and transmitted to the retailer terminal 107.
(3) Then, a retail registration is performed from the retailer terminal 107 wherein a product number of the refrigerator 101 is transmitted together with the transmitted user ID and password. Although it is not necessary to provide the user ID and password, a user is confirmed as an authorized user by the user ID and password, a correspondence between a product and the user is established, and as a result, more appropriate services, such as provision of information, are provided to the user.
(4) Thereafter, when the refrigerator 101 is connected to the network 102, a connection registration process is performed wherein the relay server 103 is notified by the refrigerator 101 of the product number and IP address of the refrigerator 101. By this operation, the access terminal ID and the IP address, which are associated with each other by collation of the product number, are registered in the connectable device database 123 of the relay server 103.

The relay control is performed in the relay control section 122 based on the above registration, whereby a communication is established between the refrigerator 101 and the cellular mobile phone 105. This communication is the same as that of embodiment 1 (FIGS. 3 and 4) except that it is necessary to input the user ID and password for accessing from the cellular mobile phone 105 to the refrigerator 101. In embodiment 2, a device used for making an access is not limited to any particular device. A user is confirmed as an authorized user by entering the user ID and password, whereby a fraudulent access is prevented.

(Embodiment 3)

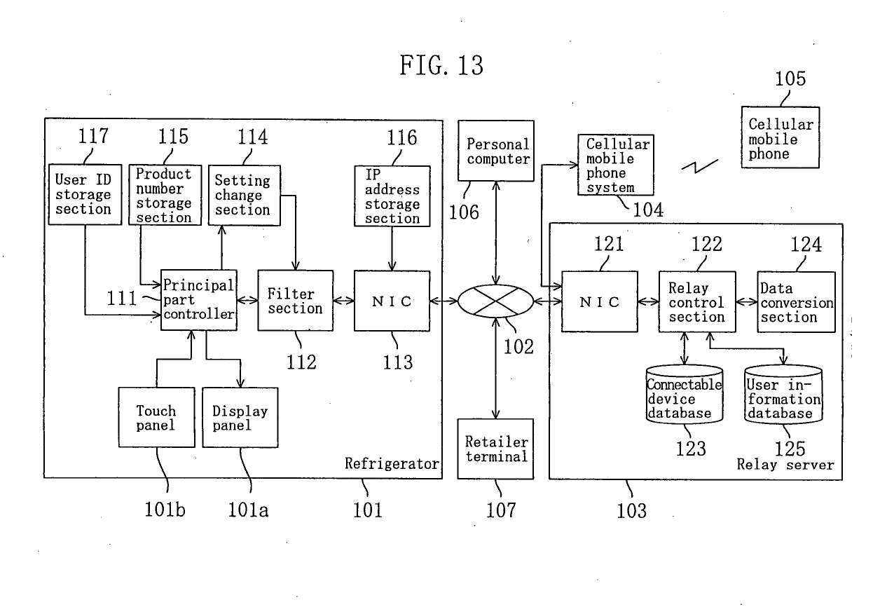

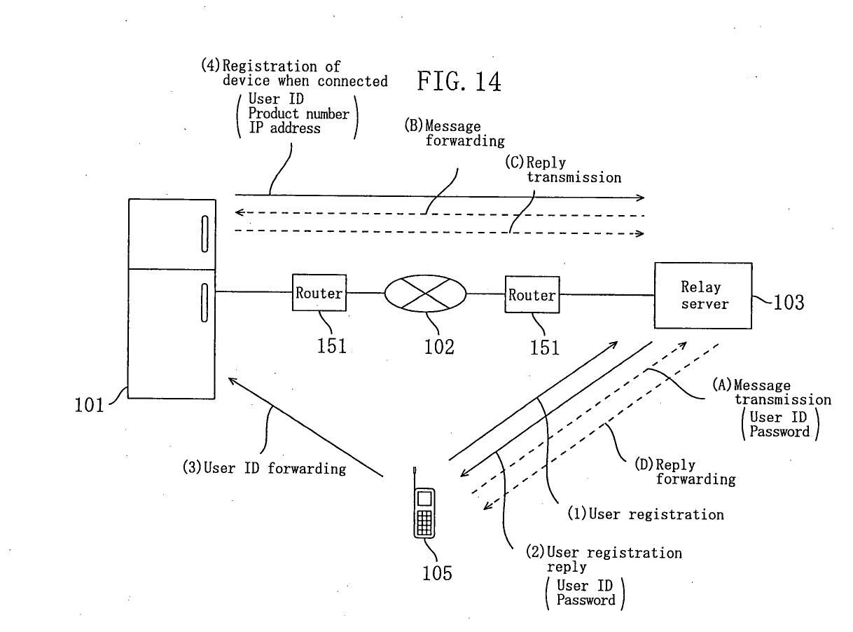

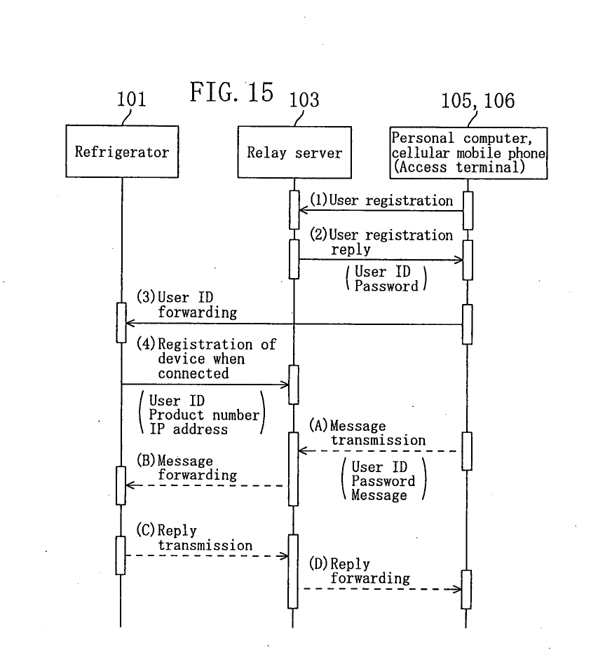

A network system of embodiment 3 can establish a communication between the cellular mobile phone 105 and the refrigerator 101. As shown in FIG. 13, the refrigerator 101 of embodiment 3 includes a user ID storage section 117 in addition to the components of the refrigerator of embodiment 1. As shown in FIGS. 14 and 15, registration by the retailer terminal 107 is not necessary, and therefore, registration in the relay server 103 is more conveniently carried out.
(1) In the first place, user registration is performed with the cellular mobile phone 105.
(2) The relay server 103 sends a user ID and password, which have been issued according to the request, to the cellular mobile phone 105.
(3) The user ID issued by the relay server 103 is forwarded to the refrigerator 101 through a communication between the cellular mobile phone 105 and the refrigerator 101. Forwarding of this user ID is not limited to any particular form but is realized by, for example, infrared communication (IrDA). More specifically, when the user ID is transmitted from the relay server 103, a control program for IrDA is transmitted together with the user ID, and then, the program is executed by the cellular mobile phone 105, whereby the user ID is forwarded to the refrigerator 101 and stored in product number storage section 115. The user ID is not necessarily forwarded by the cellular mobile phone 105 to the refrigerator 101 as described above. For example, the user ID may be input using an IC card, or the like, so long as the refrigerator 101 or a device connected thereto has the function of reading IC cards, or the like. Alternatively, the user ID may be entered by user's entry manipulation.
(4) After the user ID has been forwarded, the refrigerator 101 accesses the relay server 103 to transmit a user ID, a product number, and an IP address, whereby a connection registration process is performed. The relay server 103 collates the received user ID with a user ID which has been stored at the time of issuance of the user ID. If the user is confirmed as an authorized user, the received IP address, and the like, are registered in the connectable device database 123.

The information registered in the connectable device database 123 of the relay server 103 as described above are the same as those of the example described in embodiment 2, and based on these information, the relay control (Steps (A) to (D) described in embodiment 1) is performed in like manner. It should be noted that, since the user ID and password transmitted from the relay server 103 at the time of user registration are received and retained by the cellular mobile phone 105, the entry manipulation of the user ID and password can be omitted when the user accesses the refrigerator 101 by using the cellular mobile phone 105.

(Embodiment 4)

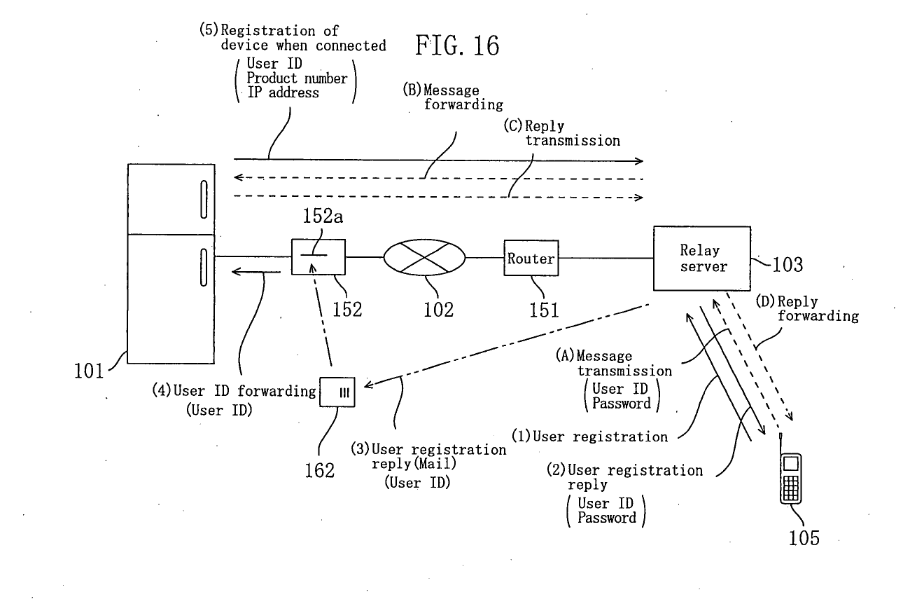

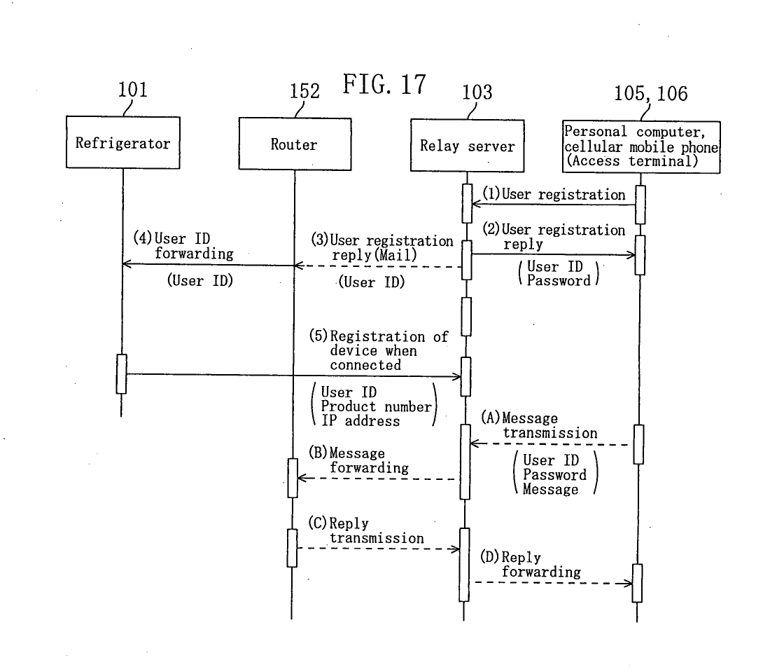

In the network system of embodiment 3, as shown in FIGS. 16 and 17, an IC card 162 in which a user ID is recorded is forwarded to the refrigerator 101 through a router 152 having an IC card slot 152a.
(1) & (2) The cellular mobile phone 105 is used to perform user registration and receive a user ID and password as described in embodiment 3.
(3) In embodiment 4, the IC card 162 in which an issued user ID is recorded is sent to a user by mail, or the like.
(4) When the IC card 162 is inserted into the IC card slot 152a of the router 152, the router 152 periodically multicasts (or broadcasts) the user ID.
(5) The operation of the refrigerator 101 and the relay server 103 which is performed after the user ID has been forwarded is the same as that described in embodiment 3. The relay control is also performed in the same manner as described in embodiment 3.

In embodiment 4, for example, when the owner of the refrigerator 101 is changed after the registration in the relay server 103 has been completed, the original user registration is deleted. Specifically, as described above, the router 152 periodically multicasts the user ID based on the IC card 162 inserted therein. If the refrigerator 101 is transferred to another user and is connected to a network where an IC card 162 of a different user is inserted in the router 152, the user ID notified by the router 152 is different from a user ID stored in the user ID storage section 117 of the refrigerator 101.

When such a mismatch is detected, the principal part controller 111 interrupts the use of services through the relay server 103, whereby a new user is prevented from using a service which is to be charged on the former user, and the former user is prevented from accessing the refrigerator 101 from the cellular mobile phone 105. When the above mismatch is detected, for example, registration is conducted at the relay server 103 with a new user ID on user's permission, or registered information of the former user which are associated with the refrigerator 101 may be deleted on user's permission. In the above case, if the refrigerator 101 is temporarily used by the different user and the former user uses the refrigerator 101 again, the registered information is kept aside without being completely deleted such that the registered information can be used again when the former user uses the refrigerator 101 again.

In order to achieve an appropriate operation even when the user is changed, it is only required that the refrigerator 101 and a device for storing the user ID are separated from each other. Thus, for example, the user ID may be transmitted to the router 152 through the cellular mobile phone 105 as in embodiment 3. Alternatively, another device connected to the local network may store the user ID.

(Other Features)

In embodiments 1 to 3, change of the user cannot be directly detected as in embodiment 4, and therefore, it is difficult to automatically delete the user registration. However, it is easy to manually delete the user registration. Specifically, the user registration information relating to the refrigerator 101 may be deleted from the retailer terminal 107 as in the user registration operation of embodiments 1 and 2 or may be deleted from the cellular mobile phone 105 as in the user registration operation of embodiment 3. Alternatively, in one possible example, deletion of the registered information is requested to the relay server 103 using the cellular mobile phone 105, and a registration deletion command, or the like, which is transmitted from the relay server 103 according to the request, is supplied to the refrigerator 101 through the cellular mobile phone 105 or the IC card 162, such that the refrigerator 101 notifies the relay server 103 about the final deletion. In this case, even if the password is leaked out, the security is still high because the final deletion is not notified when the refrigerator 101 is not on hand. Furthermore, a request for deletion may be made to the relay server 103 by manipulating the touch panel 101b of the refrigerator 101.

### INDUSTRIAL APPLICABILITY

As described above, according to the present invention, the security is readily ensured by access control, or the like, using a limited input/output interface of a household electric appliance without complicated setting manipulations.

1. (canceled)

2. (canceled)

3. (canceled)

4. (canceled)

5. (canceled)

6. A household electric appliance capable of connecting with a network, comprising:
access control means which stores a partner address indicative of a communication partner and communicates with the communication partner through the network;
product identifying information storage means for storing in advance product identifying information which identifies the household electric appliance;
address storage means for storing a product address allocated to the household electric appliance; and
address transmission means for transmitting the product identifying information and the product address to the communication partner,
wherein the access control means in the default state stores only an address of a predetermined server,
the server stores in advance product identifying information of the household electric appliance and communication device identifying information that identifies a communication device which is permitted to establish a communication with the household electric appliance,
the server stores registration information including the communication device identifying information and the product address in conjunction with each other based on the product identifying information and the communication device identifying information which are stored in the server and the product identifying information and the product address which are transmitted from the address transmission means, and
the server has the function of relaying a communication between the household electric appliance and the communication device according to the registration information.

7. A household electric appliance capable of connecting with a network, comprising:
access control means which stores a partner address indicative of a communication partner and communicates with the communication partner through the network;
product identifying information storage means for storing in advance product identifying information which identifies the household electric appliance;
address storage means for storing a product address allocated to the household electric appliance; and
address transmission means for transmitting the product identifying information and the product address to the communication partner,
wherein the access control means in the default state stores only an address of a predetermined server,
the server stores in advance product identifying information of the household electric appliance and user identifying information that identifies a user of the household electric appliance,
the server stores registration information including the user identifying information and the product address in conjunction with each other based on the product identifying information and the user identifying information which are stored in the server and the product identifying information and the product address which are transmitted from the address transmission means, and
the server has the function of relaying a communication between the household electric appliance and the communication device according to the registration information.

8. A household electric appliance capable of connecting with a network, comprising:
access control means which stores a partner address indicative of a communication partner and communicates with the communication partner through the network;
product identifying information storage means for storing in advance product identifying information which identifies the household electric appliance;
address storage means for storing a product address allocated to the household electric appliance;
user identifying information acquisition means for acquiring user identifying information that identifies a user of the household electric appliance, the user identifying information being stored by the predetermined server in a predetermined memory means; and
an address transmission means for transmitting the product identifying information, user identifying information and a product address to the communication partner,
wherein the access control means in the default state stores only an address of the server,
the server stores the user identifying information and the product address, which are transmitted from the address transmission means, as registration information in conjunction with the product identifying information stored in advance, and
the server has the function of relaying a communication between the household electric appliance and the communication device according to the registration information.

9. The household electric appliance of claim 8, wherein:
the memory means is a communication device capable of communicating with each of the household electric appliance and the server; and
the user identifying information acquisition means receives the user identifying information from the communication device.

10. The household electric appliance of claim 8, wherein:
the memory means is a recording medium insertable to the household electric appliance or a device connected to the household electric appliance; and
the user identifying information acquisition means reads the user identifying information from the recording medium.

11. The household electric appliance of claim 8, further comprising:
user identifying information storage means for storing the user identifying information obtained from the user identifying information acquisition means; and
relay interruption means for interrupting relaying of a communication between the household electric appliance and the communication device if the user identifying information stored in the user identifying information storage means is different from user identifying information newly obtained from the user identifying information acquisition means.

12. (canceled)

13. (canceled)

14. (canceled)

15. The household electric appliance of claim 6, wherein the household electric appliance is a refrigerator.

16. The household electric appliance of claim 7, wherein the household electric appliance is a refrigerator.

17. The household electric appliance of claim 8, wherein the household electric appliance is a refrigerator.

18. A server capable of communicating through a network with a household electric appliance which stores in advance product identifying information that identifies the household electric appliance, stores a product address allocated to the household electric appliance, and transmits the product identifying information and the product address to a communication partner, the server comprising:
first storage means for storing in advance product identifying information of the household electric appliance and communication device identifying information that identifies a communication device which is permitted to establish a communication with the household electric appliance;
second storage means for storing registration information including the communication device identifying information and the product address in conjunction with each other based on the information stored in the first storage means and the product identifying information and the product address which are transmitted from the household electric appliance;
household electric appliance access control means which establishes a communication through the network with the household electric appliance indicated by the product address stored in the second storage means; and
communication device access control means which establishes a communication with the communication device indicated by the communication device identifying information stored in the second storage means,
wherein the server relays a communication between the household electric appliance and the communication device.

19. (canceled)

20. (canceled)

21. A server capable of communicating through a network with a household electric appliance which stores in advance product identifying information that identifies the household electric appliance, stores a product address allocated to the household electric appliance, and transmits the product identifying information and the product address to a communication partner, the server comprising:
first storage means for storing in advance product identifying information of the household electric appliance and user identifying information that identifies a user of the household electric appliance;
second storage means for storing registration information including the user identifying information and the product address in conjunction with each other based on the information stored in the first storage means and the product identifying information and the product address which are transmitted from the household electric appliance;
household electric appliance access control means which establishes a communication through the network with the household electric appliance indicated by the product address stored in the second storage means; and
communication device access control means which establishes a communication with a predetermined communication device authenticated using the user identifying information stored in the second storage means,
wherein the server relays a communication between the household electric appliance and the communication device.

22. A server capable of communicating through a network with a household electric appliance which stores in advance product identifying information that identifies the household electric appliance, stores a product address allocated to the household electric appliance, acquires user identifying information that identifies a user of the household electric appliance which is stored in predetermined memory means, and transmits the product identifying information, the user identifying information and the product address to a communication partner, the server comprising:
first storage means for storing in advance product identifying information;
user identifying information output means which allows the memory means to store the user identifying information;
second storage means for storing the user identifying information and the product address, which are transmitted from the household electric appliance, as registration information in conjunction with the product identifying information stored in the first storage means;
household electric appliance access control means which establishes a communication through the network with the household electric appliance indicated by the product address stored in the storage means; and
communication device access control means which establishes a communication with a predetermined communication device authenticated using the user identifying information stored in the storage means,
wherein the server relays a communication between the household electric appliance and the communication device.

23. The server of claim 22, wherein:
the memory means is a communication device capable of communicating with each of the household electric appliance and the server; and
the user identifying information output means transmits the user identifying information to the communication means.

23. (canceled)

24. The server of claim 22, wherein:
the memory means is a recording medium insertable to the household electric appliance or a device connected to the household electric appliance; and
the user identifying information output means records the user identifying information in the recording medium.

25. (canceled)

26. A household electric appliance network system, comprising a server and a household electric appliance connectable to a network, wherein:
the household electric appliance includes
access control means which stores a partner address indicative of a communication partner and communicates with the communication partner through the network,
product identifying information storage means for storing in advance product identifying information which identifies the household electric appliance,
address storage means for storing a product address allocated to the household electric appliance,
an address transmission means for transmitting the product identifying information and a product address to the communication partner,
wherein the access control means in the default state stores only an address of the server; and
the server includes
first storage means for storing in advance product identifying information of the household electric appliance and communication device identifying information that identifies a communication device which is permitted to establish a communication with the household electric appliance,
second storage means for storing registration information including the communication device identifying information and the product address in conjunction with each other based on the information stored in the first storage means and the product identifying information and the product address which are transmitted by the address transmission means of the household electric appliance,
household electric appliance access control means which establishes a communication through the network with the household electric appliance indicated by the product address stored in the second storage means, and
communication device access control means which establishes a communication with the communication device indicated by the communication device identifying information stored in the second storage means,
wherein the server relays a communication between the household electric appliance and the communication device.

27. A household electric appliance network system, comprising a server and a household electric appliance connectable to a network, wherein:
the household electric appliance includes
access control means which stores a partner address indicative of a communication partner and communicates with the communication partner through the network,
product identifying information storage means for storing in advance product identifying information which identifies the household electric appliance,
address storage means for storing a product address allocated to the household electric appliance,
an address transmission means for transmitting the product identifying information and a product address to the communication partner,
wherein the access control means in the default state stores only an address of the server; and
the server includes
first storage means for storing in advance product identifying information of the household electric appliance and user identifying information that identifies a user of the household electric appliance,
second storage means for storing registration information including the user identifying information and the product address in conjunction with each other based on the information stored in the first storage means and the product identifying information and the product address which are transmitted by the address transmission means of the household electric appliance,
household electric appliance access control means which establishes a communication through the network with the household electric appliance indicated by the product address stored in the second storage means, and
communication device access control means which establishes a communication with a predetermined communication device authenticated using the user identifying information stored in the second storage means,
wherein the server relays a communication between the household electric appliance and the communication device.

28. A household electric appliance network system, comprising a server and a household electric appliance connectable to a network, wherein:
the household electric appliance includes
access control means which stores a partner address indicative of a communication partner and communicates with the communication partner through the network,
product identifying information storage means for storing in advance product identifying information which identifies the household electric appliance,
address storage means for storing a product address allocated to the household electric appliance,
user identifying information acquisition means for acquiring user identifying information that identifies a user of the household electric appliance, the user identifying information being stored by the predetermined server in a predetermined memory means, and
an address transmission means for transmitting the product identifying information, user identifying information and a product address to the communication partner,
wherein the access control means in the default state stores only an address of the server; and
the server includes
first storage means for storing in advance product identifying information,
user identifying information output means which allows the memory means to store the user identifying information,
second storage means for storing the user identifying information and the product address, which are transmitted by the address transmission means of the household electric appliance, as registration information in conjunction with the product identifying information stored in the first storage means,
household electric appliance access control means which establishes a communication through the network with the household electric appliance indicated by the product address stored in the storage means, and
communication device access control means which establishes a communication with a predetermined communication device authenticated using the user identifying information stored in the storage means,
wherein the server relays a communication between the household electric appliance and the communication device.

29. A household electric appliance network system, comprising a server and a household electric appliance connectable to a network, wherein:
the household electric appliance includes
access control means which stores a partner address indicative of a communication partner and communicates with the communication partner through the network,
product identifying information storage means for storing in advance product identifying information which identifies the household electric appliance,
address storage means for storing a product address allocated to the household electric appliance,
an address transmission means for transmitting the product identifying information and a product address to the communication partner,
wherein the access control means in the default state stores only an address of the server; and
the server includes
first storage means for storing product identifying information in advance,
second storage means for storing the product identifying information and the product address transmitted by the address transmission means of the household electric appliance in conjunction with each other as registration information, and
service provision means for providing a service related to the household electric appliance based on the registration information.

30. The household electric appliance network system of claim 29, wherein the household electric appliance is a refrigerator.
